(19) United States
(12) Patent Application Publication
(10) Pub. No.: US 2024/0422699 A1
(43) Pub. Date: Dec. 19, 2024

(54) MANAGEMENT OF ANTENNA EIRP

(71) Applicant: Microsoft Technology Licensing, LLC, Redmond, WA (US)

(72) Inventors: Marshall Joseph KATZ, Seattle, WA (US); Charbel KHAWAND, Sammamish, WA (US)

(21) Appl. No.: 18/209,302

(22) Filed: Jun. 13, 2023

(51) Int. Cl. H04W 52/36; H04W 52/52

(52) U.S. Cl. CPC H04W 52/367; H04W 52/52

(57) ABSTRACT

The disclosed technology is generally directed to management of antenna EIRP. In one example of the technology, a mobile device includes an antenna, a power amplifier, and a controller. The antenna provides an antenna output signal from an antenna input signal. A gain is associated with the antenna. An EIRP is associated with the antenna output signal. The power amplifier (PA) provides the antenna input signal from a PA input signal. The controller causes an instantaneous input power of the PA input signal to increase to a value that is greater than a threshold during part of a time window based on the gain and causes the instantaneous input power of the PA input signal to be adjusted during another part of the time window such that an average value during the time window of the EIRP that is associated with the antenna output signal is less than the threshold.

### BACKGROUND

Radiofrequency (RF) devices are subject to various regulations in many jurisdictions. For instance, in some jurisdictions, various regulations may provide details on limitations on effective isotropically radiated power (EIRP). For instance, the Federal Communications Commission (FCC) and the European Telecommunications Standards Institute (ETSI) both have regulations related to the allowed EIRP of RF devices. The limitations may vary based on different factors, such as bandwidth, device type, or other applicable factors. EIRP represents the total effective transmit power, including gains that the antenna provides and losses from the antenna cable. The gain of an antenna represents how well it increases effective signal power in a particular direction. However, such EIRP regulations may limit some capabilities of a device.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to management of antenna EIRP. In one example of the technology, a mobile device includes a first antenna, a first power amplifier, and a controller. The first antenna is arranged to provide a first antenna output signal from a first antenna input signal. A first gain is associated with the first antenna. An effective isotropically radiated power (EIRP) is associated with the first antenna output signal. The first power amplifier is arranged to provide the first antenna input signal from a first power amplifier input signal. The controller is arranged to cause an instantaneous input power of the first power amplifier input signal to increase to a value that is greater than a first defined threshold during part of a first time window based at least in part on the first gain. The controller is further arranged to cause the instantaneous input power of the first power amplifier input signal to be adjusted during another part of the first time window such that an average value during the first time window of the EIRP that is associated with the first antenna output signal is less than the first defined threshold.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating an example system for management of antenna EIRP;

FIG. 2 is a flow diagram illustrating an example process for management of antenna EIRP;

FIG. 3 is a block diagram illustrating one example of a suitable environment in which aspects of the technology may be employed; and

FIG. 4 is a block diagram illustrating one example of a suitable computing device, according to aspects of the disclosed technology.

### DETAILED DESCRIPTION

A mobile device uses one of more antennas for RF transmission, such as via Long Term Evolution (LTE) Band 30, 5G, Wi-Fi, cellular, Bluetooth, or other suitable means of communication. For a transmitter that includes at least one antenna, the EIRP for the antenna(s) is managed as follows. For each antenna, a power amplifier that is in the transmit path of the antenna feeds the antenna. The EIRP for the antenna/transmitter is managed by managing the input power to the power amplifier, based in part on the gain of the antenna/transmitter.

The input power to the power amplifier is managed to ensure that the average EIRP over each five-second time window, or a time window of another suitable duration, does not exceed a determined threshold. In various examples, the threshold is determined based on applicable regulations or based on other suitable factor(s). The input power to the power amplifier is also managed so that the instantaneous power of the EIRP exceeds the determined threshold for some portion of the time window, while still ensuring that the average EIRP for the entire time window is not exceeded. The extent to which the instantaneous EIRP exceeds the determined threshold, and the timing of when to exceed the determined threshold during the time window, including when to begin doing so and how long to do so, are based on multiple factors, including the gain of the amplifier and other suitable factors.

For instance, there may be poor throughput or another suitable transmission problem based on channel conditions or other applicable issues. The instantaneous input power is adjusted so that the instantaneous EIRP exceeds the determined threshold for at least a brief period of time while such applicable issues are occurring. In this way, in some instances, a reasonable throughput may be maintained in spite of issues that would otherwise cause a significant reduction in throughput.

In some examples, instantaneous EIRP increases are coordinated with the base station. In these examples, the base station determines how much connected mobile devices can increase their instantaneous EIRP based on the base station's assessment of existing active users and the impact of the EIRP increase on surrounding users (including considering the power density of neighboring users), and the base station uses this determination to create a time schedule that coordinates allowed instantaneous EIRP increases among connected devices.

### Illustrative Systems

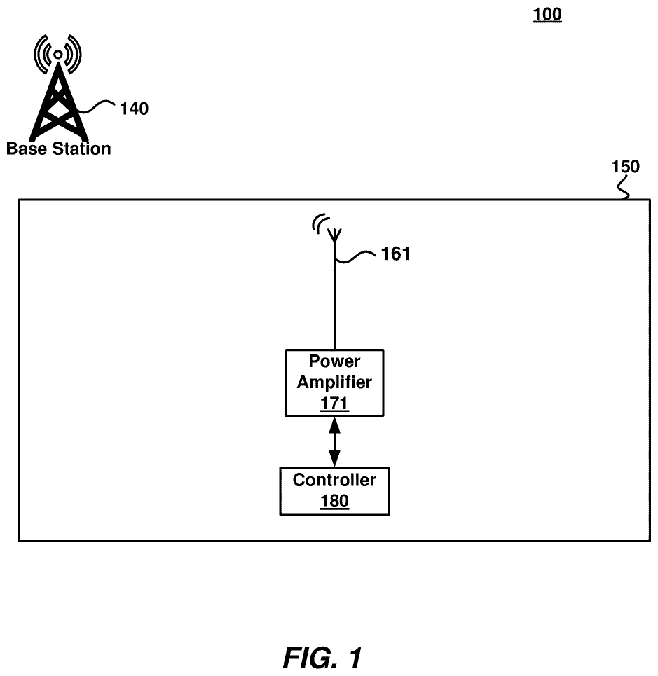

FIG. 1 shows an example of system 100. FIG. 1 and the corresponding description of FIG. 1 in the specification illustrate an example device for illustrative purposes that does not limit the scope of the disclosure. System 100 is described as follows in accordance with some examples.

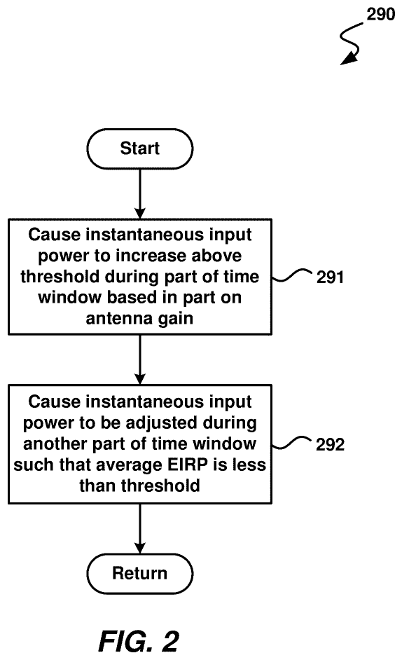

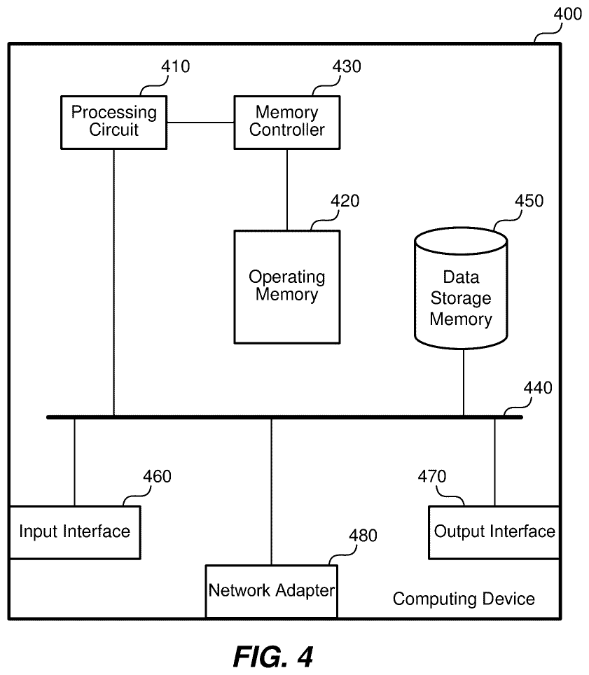

System 100 includes base station 140 and mobile device 150. Mobile device 150 includes antenna 161, power amplifier 171, and controller 180. In some examples, controller 180 includes a processor, memory, and other components as shown in the device of FIG. 4, in which processor-executable code is executed by the processor to perform actions, such as those discussed in FIG. 2 and elsewhere herein. Base station 140 enables mobile device 150 to communicate over a network via RF communication with base station 140. Mobile device 150 transmits RF signals to base station 140 via one or more antennas, including antenna 161. Base station 140 may in turn be connected to a data center that is connected to the Internet or another suitable network.

Antenna 161 transmits an antenna output signal provided at the output of antenna 161 from an antenna input signal provided at the input of antenna 161. Antenna 161 has a gain, and the antenna output has an associated EIRP. The antenna output signal is communicated from antenna 161 to base station 140. In some examples, the antenna output signal uses orthogonal frequency-division multiplexing (ODFM) modulation. In other examples, the antenna output signal uses another suitable type of modulation. The antenna output signal uses one or more wireless communication technologies, such as a fifth generation (5G) technology, a fourth generation (4G) technology, a third generation (3G) technology, one or more technologies based on one or more Institute of Electrical and Electronics Engineers (IEEE) 802.11 protocols (e.g., IEEE 802.11ac, IEEE 802.11ad, IEEE 802.11ax, IEEE 802.11ay, IEEE 802.11n), Bluetooth, or other suitable technology.

Power amplifier 171 has an output that is coupled to the input of antenna 161. Power amplifier 171 is arranged to provide the antenna input signal at the output of power amplifier 171 from a power amplifier input signal provided to the input of power amplifier 171. Controller 180 manages the EIRP of antenna 161 by managing the input power of the input signal to power amplifier 171 based in part on the gain of antenna 161.

Controller 180 manages the EIRP by controlling the input power to the power amplifier such that the average (i.e., time-averaged) EIRP of antenna 161 during a particular time window does not exceed a determined threshold. In some examples, the time window is a static time window. In other examples, the time window is a moving time window, rolling time window, or the like. The threshold may be determined based on applicable regulations or based on another suitable reason. For instance, in some examples, the input power to the power amplifier is managed to ensure that the average EIRP over each five-second time window, or a time window of another suitable duration, does not exceed the determined threshold. The input power to the power amplifier is also managed so that the instantaneous power of the EIRP exceeds the determined threshold for some portion of the time window when it is beneficial to do so for throughput reasons or the like, while still ensuring that the average EIRP for the entire time window is not exceeded.

In this way, controller 180 is arranged to adjust the input power of the first power amplifier input signal by increasing and decreasing the instantaneous input power of the first power amplifier input signal at various times. For instance, in some examples, when it is beneficial to do so, controller 180 increases an instantaneous input power of the first power amplifier input signal to a value that is greater than a first defined threshold during part of a time window based at least in part on the first gain. Further, in some examples, in a time window in which the input power to the first power amplifier input signal is so increased, controller 180 decreases the instantaneous input power of the first power amplifier input signal during another part of the time window such that an average value during the time window of the EIRP that is associated with the first antenna output signal is less than the defined threshold. Controller 180 tracks the time-averaged EIRP and uses the tracked time-averaged EIRP to determine how the input power needs to be decreased in order to ensure that the time-averaged EIRP for the time window does not exceed the defined threshold.

The extent to which the instantaneous EIRP exceeds the determined threshold, and the timing of when to exceed the determined threshold during the window, including when to begin doing so and how long to do so, are based on multiple factors, including the gain of the amplifier and other suitable factors. For instance, there may be poor throughput or another suitable transmission problem based on channel conditions or other applicable issues. The instantaneous input power is adjusted so that the instantaneous EIRP exceeds the determined threshold for at least a brief period of time while such applicable issues are occurring. In some examples, this allows for 1-2 seconds of burst power above the average power. After the 1-2 seconds of burst power, controller 180 causes the transmission power of the antenna to be backed off so that the time-averaged EIRP does not exceed the determined threshold.

For instance, in some examples, the instantaneous input power of the first input power amplifier is based on an input signal received by mobile device 150 that indicates channel conditions associated with the transmission of the antenna output signal from antenna 161 to base station 140. In some examples, the instantaneous input power of the first input power amplifier is increased based a data rate of transmission of the antenna output signal from antenna 161 to base station 140. In some examples, the instantaneous input power of the first input power amplifier is increased based on a quantity of negative acknowledgements on packets transmitted from antenna 161 to base station 140.

In various examples, controller 180 may use various information to determine the extent to which the instantaneous EIRP should exceed the threshold. For instance, in some examples, controller 180 uses information about the direction of the antenna, information about the gain of the antenna in one or more different directions, information about the location of base station 140 or another receiver, beamforming information, or the like to determine how much the power should be increased. For example, in some examples, controller 180 has information that indicates gain of the antenna in the direction of base station 140 and information related to how much the power should be increased in the direction to ensure proper throughout. Accordingly, in these examples, controlled 180 uses this information to determine how much the input power should be increased in order to ensure proper throughput to base station 140.

In some examples, controller 180 also adjusts EIRP based on scheduling that is controlled by base station 140, as follows according to some examples.

Base station 140 actively monitors at least some of: (1) the presence of active users, (2) channel usage of the base station, (3) channel usage of other communications, and (4) channel capacity and other suitable wireless performance indicators. Based on this monitoring, base station 140 determines how much connected mobile devices can increase their instantaneous EIRP based on its assessment of existing active users and the impact of the EIRP increase on surrounding users. Base station 140 uses this determination to create a time schedule that coordinates allowed instantaneous EIRP increases among connected devices.

The time schedule includes the assignment of time slots to each user in which the user may increase instantaneous EIRP. The time slots have durations and limits through protocol control blocks sent to users on the control channels of base station 140. Users can also request time slots from base station 140. For instance, mobile device 150 can make its own assessment of channel conditions and specific needs for EIRP increase and request a time slot from base station 140 or other controlling entity (such as a Wi-Fi access point or a Bluetooth master).

In some examples, controller 180 also adjusts EIRP based on newly assigned bandwidth, as follows.

The compliance limits for EIRP are typically expressed in power/bandwidth. For instance, system 100 may use an EIRP limit of 5 dBm/1 MHz averaged over 5 seconds in some examples. For this reason, when bandwidth is increased, power can be increased correspondingly while still complying with EIRP requirements. Some technologies, such as LTE and 5G New Radio (NR), operate using sub-channel Resource Block (RB) allocation over 180 KHz wide bandwidth. In some examples, the RBs are aggregated together for wider bandwidth so that power can be correspondingly increased. An RB is the smallest unit of resources that can be allocated to a user. For LTE, RBs are either 12×15 kHz subcarriers or 24×7.5 kHz subcarriers wide in frequency. The number of subcarriers used per RB for most channels and signals is 12 subcarriers. The RB is one slot long in time, where one slot is 0.5 milliseconds. RBs are allocated in pairs by a scheduler.

In some examples, controller 180 defines a number of frequency buckets, where each frequency bucket is a separate frequency range. For instance, in some examples, the frequency buckets are 1 MHz-wide wide. In some examples, controller 180 defines a separate time window for each frequency bucket. In this way, in some examples, rather than defining one EIRP limitation that applies for all frequencies, a separate EIRP limitation with its own corresponding set of time windows is defined for each frequency bucket.

As discussed above, controller 180 can cause a brief burst of power when it would be beneficial to do so while still complying with EIRP requirement. After 1-2 seconds of burst power as discussed above, if the same RBs are assigned, controller 180 backs off the transmission power as discussed above. If, however, new RBs are assigned in a different frequency bucket, and conditions continue to indicate that burst power would be beneficial, controller 180 continues to cause transmission of burst power since a new averaging window is beginning for the new frequency bucket.

While EIRP management with one antenna is discussed above, in various examples, such EIRP management is performed for multiple antennas, such as separately for each antenna, collectively for one or more antenna arrays, or the like.

By maintaining higher power in bursts, mobile device 150 increases the effective transmission distance of signals transmitted by antennas, and mobile device 150 is able to make better use of channel resources, which increases the chance of completing transactions made by mobile device 150. Also, based on the knowledge of the angle of the receiver with respect to the transmitter, mobile device 150 is able to infer the gain of the antenna and adjust the instantaneous power accordingly. This enables mobile device 150 to have increased radiated power uniformly around the antennas of mobile device 150.

### Illustrative Processes

FIG. 2 is a diagram illustrating an example dataflow for a process (290) performed, such as by controller 180 of FIG. 1. In some examples, process 290 proceeds as follows.

Step 291 occurs first. At step 291, an instantaneous input power of a first power amplifier input signal is caused to increase to a value that is greater than a first defined threshold during part of a first time window based at least in part on a first gain. A first power amplifier is arranged to provide a first transmitter input signal from a first power amplifier input signal. A first transmitter of a mobile device is arranged to provide a first transmitter output signal from the first transmitter input signal. The first gain is associated with the first transmitter. An effective isotropically radiated power (EIRP) is associated with the first transmitter output signal.

As shown, step 292 occurs next. At step 292, the instantaneous input power of the first power amplifier input signal is caused to be adjusted during another part of the first time window such that an average value during the first time window of the EIRP that is associated with the first transmitter output signal is less than the first defined threshold. The process then advances to a return block, where other processing is resumed.

### Illustrative Devices/Operating Environments

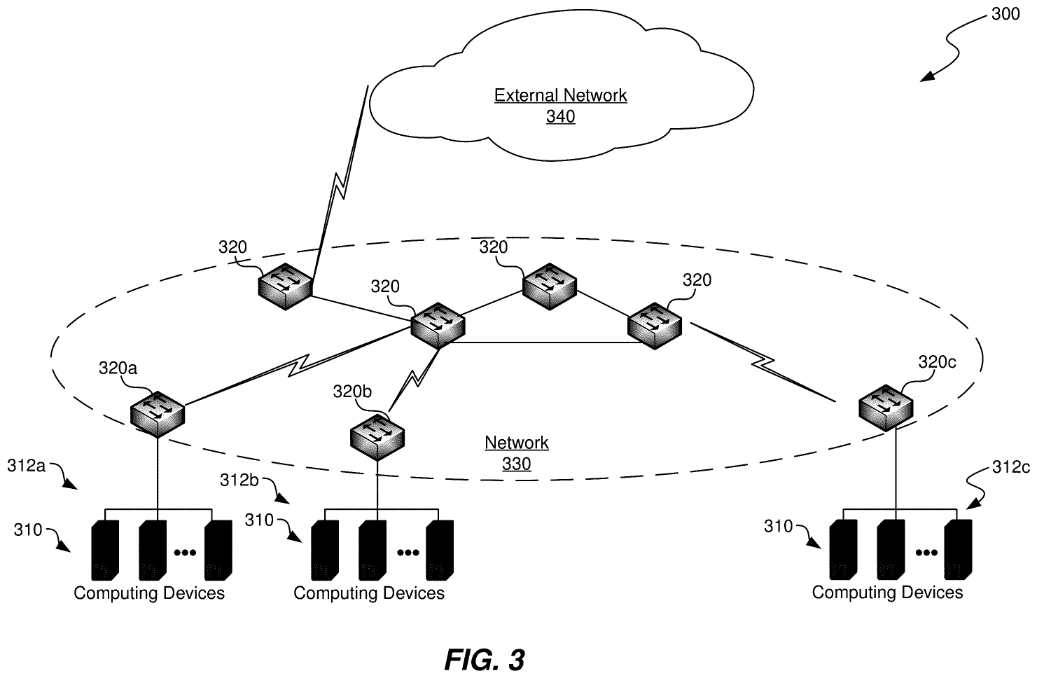

FIG. 3 is a diagram of environment 300 in which aspects of the technology may be practiced. As shown, environment 300 includes computing devices 310, as well as network nodes 320, connected via network 330. Even though particular components of environment 300 are shown in FIG. 3, in other examples, environment 300 can also include additional and/or different components. For example, in certain examples, the environment 300 can also include network storage devices, maintenance managers, and/or other suitable components (not shown). Computing devices 310 shown in FIG. 3 may be in various locations, including a local computer, on premise, in the cloud, or the like. For example, computer devices 310 may be on the client side, on the server side, or the like.

As shown in FIG. 3, network 330 can include one or more network nodes 320 that interconnect multiple computing devices 310, and connect computing devices 310 to external network 340, e.g., the Internet or an intranet. For example, network nodes 320 may include switches, routers, hubs, network controllers, or other network elements. In certain examples, computing devices 310 can be organized into racks, action zones, groups, sets, or other suitable divisions. For example, in the illustrated example, computing devices 310 are grouped into three host sets identified individually as first, second, and third host sets 312a-112c. In the illustrated example, each of host sets 312a-112c is operatively coupled to a corresponding network node 320a-120c, respectively, which are commonly referred to as “top-of-rack” or “TOR” network nodes. TOR network nodes 320a-120c can then be operatively coupled to additional network nodes 320 to form a computer network in a hierarchical, flat, mesh, or other suitable types of topology that allows communications between computing devices 310 and external network 340. In other examples, multiple host sets 312a-112c may share a single network node 320. Computing devices 310 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 310 may be individually configured to provide computing, storage, and/or other suitable computing services.

In some examples, one or more of the computing devices 310 is a device that is configured to be at least part of a system for management of antenna EIRP.

### Illustrative Computing Device

FIG. 4 is a diagram illustrating one example of computing device 400 in which aspects of the technology may be practiced. Computing device 400 may be virtually any type of general- or specific-purpose computing device. For example, computing device 400 may be a user device such as a desktop computer, a laptop computer, a tablet computer, a display device, a camera, a printer, or a smartphone. Likewise, computing device 400 may also be a server device such as an application server computer, a virtual computing host computer, or a file server computer. In some examples, computing device 400 is a mobile device that is an example of mobile device 150 of FIG. 1. As illustrated in FIG. 4, computing device 400 may include processing circuit 410, operating memory 420, memory controller 430, bus 440, data storage memory 450, input interface 460, output interface 470, and network adapter 480. Each of these afore-listed components of computing device 400 includes at least one hardware element.

Computing device 400 includes at least one processing circuit 410 configured to execute instructions, such as instructions for implementing the herein-described workloads, processes, and/or technology. Processing circuit 410 may include a microprocessor, a microcontroller, a graphics processor, a coprocessor, a field-programmable gate array, a programmable logic device, a signal processor, and/or any other circuit suitable for processing data. The aforementioned instructions, along with other data (e.g., datasets, metadata, operating system instructions, etc.), may be stored in operating memory 420 during run-time of computing device 400. Operating memory 420 may also include any of a variety of data storage devices/components, such as volatile memories, semi-volatile memories, random access memories, static memories, caches, buffers, and/or other media used to store run-time information. In one example, operating memory 420 does not retain information when computing device 400 is powered off. Rather, computing device 400 may be configured to transfer instructions from a non-volatile data storage component (e.g., data storage component 450) to operating memory 420 as part of a booting or other loading process. In some examples, other forms of execution may be employed, such as execution directly from data storage component 450, e.g., execute In Place (XIP).

Operating memory 420 may include 4th generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), magnetoresistive random access memory (MRAM), pseudorandom random access memory (PSRAM), and/or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 410 via memory controller 430 in channels. One example of computing device 400 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above discussion, operating memory 420 specifically does not include or encompass communications media, any communications medium, or any signals per se.

Memory controller 430 is configured to interface processing circuit 410 to operating memory 420. For example, memory controller 430 may be configured to interface commands, addresses, and data between operating memory 420 and processing circuit 410. Memory controller 430 may also be configured to abstract or otherwise manage certain aspects of memory management from or for processing circuit 410. Although memory controller 430 is illustrated as a single memory controller separate from processing circuit 410, in other examples, multiple memory controllers may be employed, memory controller(s) may be integrated with operating memory 420, and/or the like. Further, memory controller(s) may be integrated into processing circuit 410. These and other variations are possible.

In computing device 400, data storage memory 450, input interface 460, output interface 470, and network adapter 480 are interfaced to processing circuit 410 by bus 440. Although FIG. 4 illustrates bus 440 as a single passive bus, other configurations, such as a collection of buses, a collection of point-to-point links, an input/output controller, a bridge, other interface circuitry, and/or any collection thereof may also be suitably employed for interfacing data storage memory 450, input interface 460, output interface 470, and/or network adapter 480 to processing circuit 410.

In computing device 400, data storage memory 450 is employed for long-term non-volatile data storage. Data storage memory 450 may include any of a variety of non-volatile data storage devices/components, such as non-volatile memories, disks, disk drives, hard drives, solid-state drives, and/or any other media that can be used for the non-volatile storage of information. However, data storage memory 450 specifically does not include or encompass communications media, any communications medium, or any signals per se. In contrast to operating memory 420, data storage memory 450 is employed by computing device 400 for non-volatile long-term data storage, instead of for run-time data storage.

Also, computing device 400 may include or be coupled to any type of processor-readable media such as processor-readable storage media (e.g., operating memory 420 and data storage memory 450) and communication media (e.g., communication signals and radio waves). While the term processor-readable storage media includes operating memory 420 and data storage memory 450, the term “processor-readable storage media,” throughout the specification and the claims, whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 400 also includes input interface 460, which may be configured to enable computing device 400 to receive input from users or from other devices. In addition, computing device 400 includes output interface 470, which may be configured to provide output from computing device 400. In one example, output interface 470 includes a frame buffer, graphics processor, graphics processor or accelerator, and is configured to render displays for presentation on a separate visual display device (such as a monitor, projector, virtual computing client computer, etc.). In another example, output interface 470 includes a visual display device and is configured to render and present displays for viewing. In yet another example, input interface 460 and/or output interface 470 may include a universal asynchronous receiver/transmitter (UART), a Serial Peripheral Interface (SPI), Inter-Integrated Circuit (I2C), a General-purpose input/output (GPIO), and/or the like. Moreover, input interface 460 and/or output interface 470 may include or be interfaced to any number or type of peripherals.

In the illustrated example, computing device 400 is configured to communicate with other computing devices or entities via network adapter 480. Network adapter 480 may include a wired network adapter, e.g., an Ethernet adapter, a Token Ring adapter, or a Digital Subscriber Line (DSL) adapter. Network adapter 480 may also include a wireless network adapter, for example, a Wi-Fi adapter, a Bluetooth adapter, a ZigBee adapter, a Long-Term Evolution (LTE) adapter, SigFox, LoRa, Powerline, or a 4G adapter.

Although computing device 400 is illustrated with certain components configured in a particular arrangement, these components and arrangements are merely one example of a computing device in which the technology may be employed. In other examples, data storage memory 450, input interface 460, output interface 470, or network adapter 480 may be directly coupled to processing circuit 410 or be coupled to processing circuit 410 via an input/output controller, a bridge, or other interface circuitry. Other variations of the technology are possible.

Some examples of computing device 400 include at least one memory (e.g., operating memory 420) having processor-executable code stored therein, and at least one processor (e.g., processing unit 410) that is adapted to execute the processor-executable code, wherein the processor-executable code includes processor-executable instructions that, in response to execution, enables computing device 400 to perform actions, where the actions may include, in some examples, actions for one or more processes described herein.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “cloud” or “cloud computing” refers to shared pools of configurable computer system resources and higher-level services over a wide-area network, typically the Internet. “Edge” devices refer to devices that are not themselves part of the cloud but are devices that serve as an entry point into enterprise or service provider core networks.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a mobile device, including:
a first antenna that is arranged to provide a first antenna output signal from a first antenna input signal, wherein a first gain is associated with the first antenna, and wherein an effective isotropically radiated power (EIRP) is associated with the first antenna output signal;
a first power amplifier that is arranged to provide the first antenna input signal from a first power amplifier input signal; and
a controller that is arranged to adjust an input power of the first power amplifier input signal by:
causing an instantaneous input power of the first power amplifier input signal to increase to a value that is greater than a first defined threshold during part of a first time window based at least in part on the first gain; and
causing the instantaneous input power of the first power amplifier input signal to be adjusted during another part of the first time window such that an average value during the first time window of the EIRP that is associated with the first antenna output signal is less than the first defined threshold.

2. The apparatus of claim 1, wherein the controller is further arranged to determine when to cause the instantaneous input power of the first power amplifier to increase based at least in part on determined channel conditions associated with the first antenna output signal.

3. The apparatus of claim 1, wherein the controller is further arranged to determine when to cause the instantaneous input power of the first power amplifier to increase based at least in part on a determined throughput that is associated with the first antenna output signal.

4. The apparatus of claim 1, wherein the controller is further arranged to determine how much to cause the instantaneous power of the first power amplifier to be increased above the first defined threshold based, at least in part, on information that is associated with a direction of transmission and information that is associated with gain in the direction of transmission.

5. The apparatus of claim 1, wherein the first antenna includes an array of antennas.

6. The apparatus of claim 1, wherein the controller is further arranged to:
determine a first resource block assigned to the mobile device;
determine a first frequency range that is associated with the first resource block;
cause the instantaneous input power of the first power amplifier input signal to be adjusted during said another part of the first time window such that the average value during the first time window of the EIRP that is associated with the first antenna output signal is less than the first defined threshold such that the first time window applies to the first frequency range;
determine a second resource block assigned to the mobile device;
determine a second frequency range that is associated with the second resource block; and
upon determining that the second frequency range is different from the first frequency range:
cause an instantaneous input power of the first power amplifier input signal to increase to a value that is greater than a first defined threshold during part of a second time window based at least in part on the first gain; and
cause the instantaneous input power of the first power amplifier input signal to be adjusted during another part of the second time window such that an average value during the second time window of the EIRP that is associated with the first antenna output signal at the second frequency range is less than the first defined threshold.

7. The apparatus of claim 1, wherein the first amplifier output signal is modulated via orthogonal frequency-division multiplexing modulation.

8. A method, comprising:
causing an instantaneous input power of a first power amplifier input signal to increase to a value that is greater than a first defined threshold during part of a first time window based at least in part on a first gain, wherein a first power amplifier is arranged to provide a first transmitter input signal from a first power amplifier input signal, a first transmitter of a mobile device is arranged to provide a first transmitter output signal from the first transmitter input signal, the first gain is associated with the first transmitter, and wherein an effective isotropically radiated power (EIRP) is associated with the first transmitter output signal; and
causing the instantaneous input power of the first power amplifier input signal to be adjusted during another part of the first time window such that an average value during the first time window of the EIRP that is associated with the first transmitter output signal is less than the first defined threshold.

9. The method of claim 8, wherein the first transmitter includes at least one antenna.

10. The method of claim 8, further comprising determining when to cause the instantaneous input power of the first power amplifier to increase based at least in part on determined channel conditions associated with the first transmitter output signal.

11. The method of claim 8, further comprising determining when to cause the instantaneous input power of the first power amplifier to increase based at least in part on a determined throughput that is associated with the first transmitter output signal.

12. The method of claim 8, further comprising determining how much to cause the instantaneous power of the first power amplifier to be increased above the first defined threshold based, at least in part, on information that is associated with a direction of transmission and information that is associated with gain in the direction of transmission.

13. The method of claim 8, further comprising:
determining a first resource block assigned to the mobile device;
determining a first frequency range that is associated with the first resource block;
causing the instantaneous input power of the first power amplifier input signal to be adjusted during said another part of the first time window such that the average value during the first time window of the EIRP that is associated with the first transmitter output signal is less than the first defined threshold such that the first time window applies to the first frequency range;
determining a second resource block assigned to the mobile device;
determining a second frequency range that is associated with the second resource block; and
upon determining that the second frequency range is different from the first frequency range:
causing an instantaneous input power of the first power amplifier input signal to increase to a value that is greater than a first defined threshold during part of a second time window based at least in part on the first gain; and
causing the instantaneous input power of the first power amplifier input signal to be adjusted during another part of the second time window such that an average value during the second time window of the EIRP that is associated with the first transmitter output signal at the second frequency range is less than the first defined threshold.

14. The method of claim 8, further comprising modulating the first amplifier output signal via orthogonal frequency-division multiplexing modulation.

15. A processor-readable storage medium, having stored thereon processor-executable code that, upon execution by at least one processor, enables actions, comprising:
causing an instantaneous input power of a first power amplifier input signal to increase to a value that is greater than a first defined threshold during part of a first time window based at least in part on a first gain, wherein the first power amplifier is arranged to provide a first antenna input signal from a first power amplifier input signal, a first antenna of a mobile device is arranged to provide a first antenna output signal from the first antenna input signal, the first gain is associated with the first antenna, and wherein an effective isotropically radiated power (EIRP) is associated with the first antenna output signal; and
causing the instantaneous input power of the first power amplifier input signal to be adjusted during another part of the first time window such that an average value during the first time window of the EIRP that is associated with the first antenna output signal is less than the first defined threshold.

16. The processor-readable storage medium of claim 15, the actions further comprising determining when to cause the instantaneous input power of the first power amplifier to increase based at least in part on determined channel conditions associated with the first antenna output signal.

17. The processor-readable storage medium of claim 15, the actions further comprising determining when to cause the instantaneous input power of the first power amplifier to increase based at least in part on a determined throughput that is associated with the first antenna output signal.

18. The processor-readable storage medium of claim 15, the actions further comprising determining how much to cause the instantaneous power of the first power amplifier to be increased above the first defined threshold based, at least in part, on information that is associated with a direction of transmission and information that is associated with gain in the direction of transmission.

19. The processor-readable storage medium of claim 15, the actions further comprising:
determining a first resource block assigned to the mobile device;
determining a first frequency range that is associated with the first resource block;
causing the instantaneous input power of the first power amplifier input signal to be adjusted during said another part of the first time window such that the average value during the first time window of the EIRP that is associated with the first antenna output signal is less than the first defined threshold such that the first time window applies to the first frequency range;
determining a second resource block assigned to the mobile device;
determine a second frequency range that is associated with the second resource block; and
upon determining that the second frequency range is different from the first frequency range:
causing an instantaneous input power of the first power amplifier input signal to increase to a value that is greater than a first defined threshold during part of a second time window based at least in part on the first gain; and
causing the instantaneous input power of the first power amplifier input signal to be adjusted during another part of the second time window such that an average value during the second time window of the EIRP that is associated with the first antenna output signal at the second frequency range is less than the first defined threshold.

20. The processor-readable storage medium of claim 15, the actions further comprising causing the first amplifier output signal to be modulated via orthogonal frequency-division multiplexing modulation.
